(19) United States
(12) Patent Application Publication
(10) Pub. No.: US 2018/0056134 A1
(43) Pub. Date: Mar. 1, 2018

(54) Gemini belay carabiner with reactive gate technology

(71) Applicant: Young Chu, Fullerton, CA (US)

(72) Inventor: Young Chu, Fullerton, CA (US)

(21) Appl. No.: 15/330,195

(22) Filed: Aug. 23, 2016

(51) Int. Cl. A63B 29/02; F16B 45/02; A62B 35/00

(52) U.S. Cl. CPC A63B 29/02; A62B 35/0037; F16B 45/02

(57) ABSTRACT

This invention is a device to improve the safety of rock climbing and mountaineering participants by use of a reactive joint that allows the simultaneous opening of both gates of a double gate carabiner by manipulation of the action gate that results in the opening of the reaction gate in concert with the action gate, resulting in both gates being opened with only one hand movement by the climber.

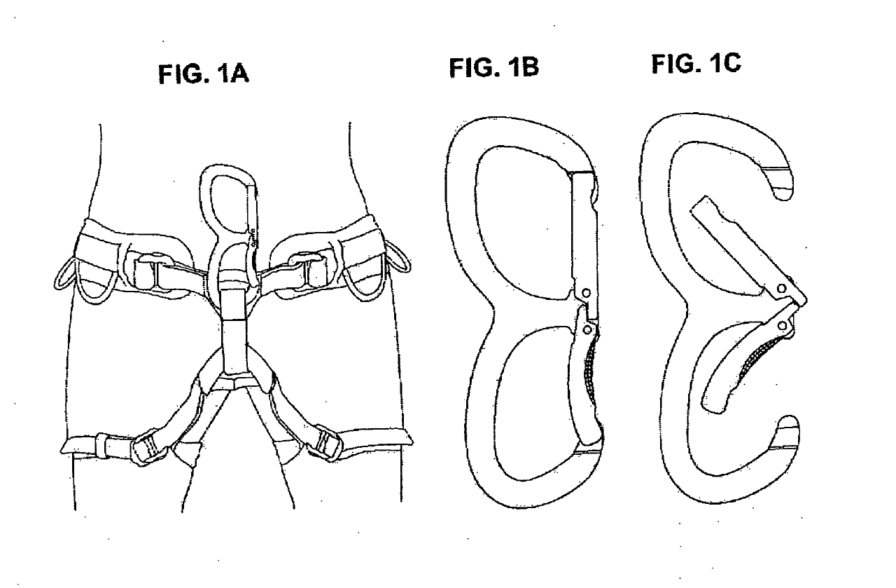

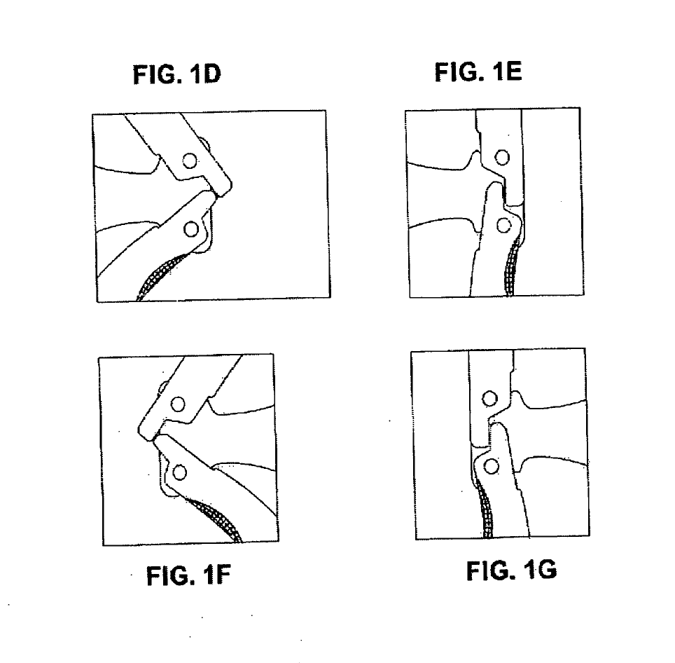

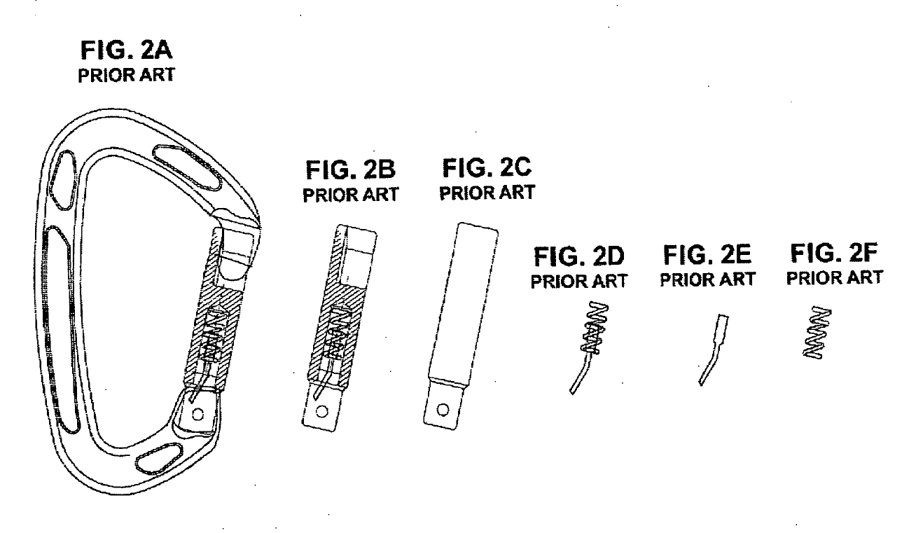

### CROSS-REFERENCE TO RELATED APPLICATIONS

There are previous applications to reference in this present application. In August 2015 this applicant filed an application for an invention titled: “DOUBLE GATE CARABINER with upper and lower spaces utilizing two ropes or anchors to improve safety for climber”. The Double Gate carabiner concept is further enhanced for safety purposes by the Gemini Belay Carabiner with Reactive Gate Technology that allows simultaneous opening of both gates to assure a smooth and safe transition from a belay position to another climbing position. The Gemini Belay Carabiner with Reactive Gate Technology eliminates the danger of the carabiner flipping into a bad alignment and cross loading. Cross loading occurs when the climbing rope or belay strap loads the carabiner on the short axis thereby reducing the loading power of the carabiner by two-thirds.

This application incorporates by reference all the embodiment's and claims and drawings set out in the prior application entitled “DOUBLE GATE CARABINER with upper and lower spaces utilizing two ropes or anchors to improve safety for climber” as though set forth in full in this application.

### STATEMENT AS TO RIGHTS TO INVENTIONS MADE UNDER FEDERALLY SPONSORED RESEARCH AND DEVELOPMENT

Not applicable

### REFERENCE TO A “SEQUENCE LISTING,” A TABLE, OR A COMPUTER PROGRAM LISTING APPENDIX SUBMITTED ON A COMPUTER DISK

Not applicable

### BACKGROUND OF THE INVENTION AND PRIOR ART

This invention relates to mechanical coupling mechanisms used in rock climbing or mountaineering where there is a strong focus on safety, strength and weight of the equipment. This invention relates to an improved carabiner system by adding a Reactive Joint to the area of attachment of both gates of the Gemini Belay Carabiner The Reactive Joint allows the simultaneous opening of both gates by the manipulation of the action gate into the open position which automatically opens the reaction gate by virtue of the Reactive Gate Technology. The Reactive Gate Technology works on the theory of a mechanical device that allows the opening of the action gate to open the reaction gate by force being applied from the opposing tangs on each gate resulting in the movement of the reaction gate in concert with the action gate, thus resulting in both gates being open at the same time for insertion or removal of a belay strap or climbing rope.

The following references provide supplemental and background information for this invention.

1. Climbing Dictionary & Glossary—(http:www.mountaindays.net/content/articles/dictionary.php#karabiner).

2. carabiner used for fall protection in US industry are classified as “connectors” and are required to meet Occupational Safety and Health Administration standard 1910.66 App C Personnel Fall Arrest System which specifies “drop forged, pressed or formed steel, or made of equivalent materials” and a minimum breaking strength (MBS) of 5,000 lbf.

3. ANSI/American Society of Safety Engineers standard ANSI Z359.1 1-2007 Safety Requirement for Personnel Fall arrest Systems, section 3.2.1.4 for snap hooks and carabiner requires that all connectors/carabiner support a (MBS) of 5,000 lbf and feature an auto-locking gate mechanism which supports a MBS of 3,600 lbf.

4. Minimum breaking strength requirements and calculations for rescue carabiner are set out in National Fire Protection Association standard 1983 Fire Service Life Safety Rope and Equipment.

5. Patent Number U.S. Pat. No. 5,329,675 A—carabiner with thumb grip.

6. Double Clips/US D607712 S1—Patent depicting a Standard Opposing Double Gate carabiner Gates are on opposite sides of the device making opening the two gates with one hand simultaneously nearly impossible.

7. Karabiners/US 2002005032 A1—Patent depicting a carabiner with one interstitial region for rope or anchor application. With insertion of two rope or anchors it is impossible to open the wire gate until tension on the device is released. No changing of rope or anchor on face of vertical rock.

8. Double carabiner/U.S. Pat. No. 5,940,943 A—Patent depicting a double interstitial region on opposing sides of the carabiner. With the insertion of a rope or anchor in each region neither the wire or metal gate can be safely opened with tension on the device. Layout of the device poses the additional danger the tension on the device could rest fully on the wire or metal gates.

9. Double carabiner/US D646556 S1—Patent depicting a double gate carabiner in S figure design with opposing gate. Opening both gates with one hand is impossible under a tension load.

10. Wire-gate carabiner/U.S. Pat. No. 8,234,761 B2—Patent depicting the standard wire gate used on most carabiner

11. carabiner having dual gates and associated methods/U.S. Pat. No. 7,946,006 B2—Patent depicting two wire gates or one wire and other metal on one side of carabiner, one gate opens in and other opens out. Cannot access single interstitial region under tension load.

12. Safety carabiner comprising a double gate/US 20140373320 A1—Patent depicting a C shaped device with two wire or metal gates or combination of same with the gates opening in the opposite direction to each other. Has only one interstitial region that cannot be accessed under tension load.

According to the invention, a carabiner or a mountaineering carabiner or a safety carabiner is a mechanical device used to link rope, slings, other climbing aids together to allow a climber of any inclined surface to remain anchored for safety to the surface while moving up, down or laterally across the surface. In the event of a fall the climber will be caught by the safety rope as it becomes taught and pulls against the anchor.

This invention introduces a carabiner designed to facilitate the simultaneous opening of both lower and upper gates by the use of reactive gate technology that opens both gates when the bottom gate is activated. Additionally the lower gate is slightly curved to allow the climber to identify it by feel and has a serrated surface on the outer edge to assist in opening the gates.

A carabiner is a snap-hook used to attach a climber's body harness belay strap to the climbing safety rope which connects to the anchor. carabiner are a basic tool in the equipment of a climber, and are used to clip ropes and anchors and other safety protection together in a variety of configurations. Often times, it is necessary for the climber to unclip the carabiner from the climbing rope while isolated in a safe position and clip another rope or ropes into the body of the carabiner, without being able to look at the carabiner, or the rope or ropes.

With conventional carabiner, it is difficult, through feel alone, to be able to properly orient the carabiner for easy clipping of ropes therein. Of course, if the climber is required to look at the carabiner while using it, he or she may be distracted from other important climbing activities.

All climbing equipment, including carabiner, should be lightweight, yet strong enough to provide safe service of all functions that might be needed by the climber. Also the easier a carabiner can be opened and the rope or belay loop inserted could mean life or death for a climber.

### SUMMARY OF INVENTION

This invention was designed to provide a new and safer carabiner by extending the safety net for climbers with improvement to the Double Gate carabiner to include Reactive Gate Technology and our new and improved Serrated Thumb Grip area on the outside of the lower gate.

Reactive Gate Technology provides a means of opening both gates at the same time by depressing only the lower gate. The lower gate is the action gate that opens the upper gate which is the reaction gate. This simultaneous opening is accomplished by the interlocking shank on each gate at the spring area with each shank resting side by side before engagement of the lower action gate.

Upon engagement of the lower action gate the shank pushes the reaction gate shank outward which causes the reaction gate to be opened inward. The climber accomplishes two important tasks by depressing the lower gate. The climber always knows by feel which gate is being operated by touching the serrated area on the outside of the curved lower or action gate. The climber is also aided in opening the curved action gate by the non-slip Serrated Thumb Grip. The non-slip Serrated Thumb Grip area allows any climber to operate the action gate without a loss of traction or fear their thumb will slip off the metal of the carabiner.

The reaction gate of the carabiner can be opened alone by depressing the gate without opening the action gate. Simultaneous opening of the gates is accomplished only by operation of the action gate in this embodiment of the invention. Other embodiment's of this invention encompass the claims that each gate can be both action and reaction gate/s with dual Serrated Thumb Grip areas to provide simultaneous opening.

### DRAWINGS

Drawing 1 is a depiction of the Gemini Belay carabiner in use. FIG. (1A) depicts the carabiner attached to the belay strap of the climber's harness in preparation for insertion of the belay rope. FIG. (1B) depicts the Gemini Belay carabiner in the closed position with the lower gate showing the Serrated Thumb Grip area. FIG. (1C) depicts the Gemini Belay carabiner in the open position displaying the action of the Reactive Gate. (1D)(1F) depicts the Reactive Gate with a front view of the Reactive Gate Technology showing the action of the lower gate by the shank contacting and moving the shank on the end of the upper gate. The back view depicts the actions of the shanks on each gate moving to open both gates. FIG. (1E)(1G) depicts “the at rest” position of the shanks of each gate from both a front and back view.

Drawing 2 is a depiction of a Standard carabiner. FIG. (2A) depicts the carabiner with the gate closed and a view of the gate spring assembly to show the operation of the gate. FIG. (2b) depicts the gate with spring assembly separated from the carabiner. FIG. (2C) depicts the gate without the spring assembly. FIG. (2D) depicts the entire spring assembly. FIG. (2E) depicts the spring rod which is encased by the spring. FIG. (2F) depicts the spring in the gates of the Gemini Belay carabiner with Reactive Gate Technology.

The drawings are an integral part of the system in this invention and by this reference are incorporated herein as though set forth in full.

1. The system in this invention comprising a Gemini Belay carabiner with Reactive Gate Technology has a lower and upper gate as embodied in the previous application for the Double Gate carbine. Any embodiment's arising out of the claims set out in this application and the Double Gate carabiner application are by reference made a part of this invention and,
The system in this invention provides provides Reactive Gate Technology that allows the operation of the lower gate to mechanically open the upper gate by means of a shank that is a part of the body of the lower gate to engage a shank that is a part of of the body of the upper gate and,
further provides double gates with double shanks that allows the operation of the lower gate to mechanically open the upper gate and,
The system in this invention provides that the upper gate may be opened by operation of depressing the gate inward without simultaneous opening of the lower gate and,
The system in this invention comprises a Serrated Thumb Grip that allows a climber to locate the lower gate by feel alone and to operate the gate easily because of the non-slip serrated grip area and,
the Gemini Belay carabiner includes at least an interstitial region in both lower and upper gates for receiving a portion of the user's finger/s so as to facilitate the opening of the gate/s and,
the Gemini Belay carabiner includes in the interstitial region of each gate a through region and,
the Gemini Belay carabiner is characterized in that the reactive gate technology encompasses any configuration or means used to simultaneously open both gates on any type of double gate carabiner by single or dual shanks attached to the gate/s to mechanically or otherwise push either gate open or closed and,
the Gemini Belay carabiner gates can be opened by the lower gate opening both gates simultaneously or any configuration whereby the upper gate opens both gates simultaneously.
